(19) United States
(12) Patent Application Publication
(10) Pub. No.: US 2004/0088952 A1
(43) Pub. Date: May 13, 2004

(54) Apparatus for perforating a packing film

(75) Inventor: Catello Di Carlo, Bologna (IT)

Correspondence Address: Richard J. Minnich, Esq., Fay, Sharpe, Fagan, Minnich & McKee, LLP, Seventh Floor, 1100 Superior Avenue, Cleveland, OH, 44114-2518, US

(73) Assignee: T.M.C. S.p.A

(21) Appl. No.: 10/292,724

(22) Filed: Nov. 12, 2002

(51) Int. Cl. B65B 63/00; B26F 1/24

(52) U.S. Cl. 53/520; 83/660

(57) ABSTRACT

An apparatus (1) for perforating a packing film (6), provided with a rotating cutter (2) and with a fixed cutter (3), respectively fitted with related single blades (4, 5), between which the packing film (6) advances proceeding along an interposed plane of lay (7), comprises blade-holding supports (8, 9) removable together with the respective blade (4, 5) for the quick replacement of the blades (4, 5) from the work area.

### BACKGROUND OF THE INVENTION

The present invention relates to an apparatus for perforating a packing film, in particular made of plastic material, for the collective wrapping of products.

In packaging machines, provided for instance to effect the collective packaging of paper rolls for home or hygienic use, the practice is known of feeding the packaging machine with a continuous film which: is unwound from a reel; perforated along suitably distanced cutting lines; and then ripped in sheets, in which the products are subsequently wrapped; the whole operation taking place with an automated process.

The operations for perforating the film, preparatory to the separation lines of the sheets, can be carried out in different ways. One of such ways provides for the use of perforating apparatuses provided with a rotating cutter and with a fixed cutter, opposing each other, between which the packing film advances proceeding along an interposed plane of lay.

The blades for perforating the film are housed in seats for the containment of the related cutters; seats with which they are made integral by means of a multiplicity of connecting screws distributed at suitable intervals on the length of the blade itself.

To access the blade, in order to perform its adjustment or replacement consequently, for instance, to operating wear, such apparatuses require all of the screws to be loosened. The opposite operation needs to be performed when mounting the blade on the respective cutters; all this taking place without neglecting an accurate beating of the blade along its entire length, in order to determine its uniform and regular setting in the fastening seat.

All these operations entail a certain difficulty of execution and non negligible operating times whereto correspond equally long machine idle times; by way of indication, replacing the blades entails having the machine lie idle for no less than about 30 minutes.

The aim of the present invention is to allow replacing the blades in considerably shorter times.

### SUMMERY OF THE INVENTION

In accordance with the invention this aim is achieved by an apparatus for perforating a packing film, provided with a rotating cutter and with a fixed cutter, respectively fitted with related single blades, between which the packing film advances proceeding along an interposed plane of lay, characterised in that it comprises blade-holding supports that are removable together with their respective blade.

The ability to remove the blades together with their blade-holding supports advantageously allows to fit the blades in the cutters on a work bench beforehand and to replace them when the blades have been correctly readied and duly checked. Moreover, since the supports of the rotating blade are provided a few fastening screws and the supports of the fixed blade are provided with pneumatic rapid locking means, the installation of the cutters on the machine is extremely rapid, entailing machine idle times in the order of about 4 minutes.

The perforating apparatus is also provided with a support frame for sustaining the rotating and fixed cutters in such a way as to allow them to be adjusted also while the apparatus is in use. The frame is provided, for this purpose, with an articulated arm that supports the fixed cutter allowing it to be adjusted relative to the rotary cutter upon operation of micrometric actuation means.

The rapidity of replacement of the blades, along with the fact that the blades can be constructed in the form of segments, independently removable from their support, yields the additional advantage of allowing to manage the operation of the blades according to the format of the film being processed and to the greater or lesser localisation of wear on individual segments. Since wear does not distribute uniformly along the length of the blade, but is accentuated on those portions of blades that are not repeatedly involved by the various formats of the film being processed, the rapidity of the replacement times allows to manage blade wear in a manner that is selectively addressed to those blade portions or to those blade segments that should be subjected to closer and more frequent monitoring.

### BRIEF DESCRIPTION OF THE DRAWINGS

The technical features of the invention, according to the aforesaid aims, can be clearly noted from the content of the claims set out below and its advantages shall become more readily apparent in the detailed description that follows, made with reference to the accompanying drawings, which represent an embodiment provided purely by way of non limiting example, in which:

FIG. 1 is an overall elevation view of the apparatus shown with some parts removed the better to highlight others;

FIG. 2 is a view of the apparatus of FIG. 1 seen from point “A”.

### DESCRIPTION OF THE PREFERRED EMBODIMENTS

With reference to the accompanying drawings, the number 1 globally indicates an apparatus for perforating a packing film 6, made of plastic material, essentially provided with a rotating cutter 2 and with a fixed cutter 3, respectively fitted with related single blades 4, 5, between which the packing film 6 advances along a direction indicated with arrow 15, proceeding along an interposed plane of lay 7. The rotating blade 2 includes a rotating drum 10 provided with at least a seat 11 so shaped as to house a blade-holding support 8, with which the related blade 4 is made integral by means of conventional fastening means constituted for instance by a plurality of fastening screws distributed along the length of the blade 4 itself. The seat 11 is accessible in the direction transverse to the axis 12 of rotation of the drum 10 in such a way as to allow the maintenance and/or removal of the support 8 and of the blade 4, mutually integral, according to the aforesaid transverse direction.

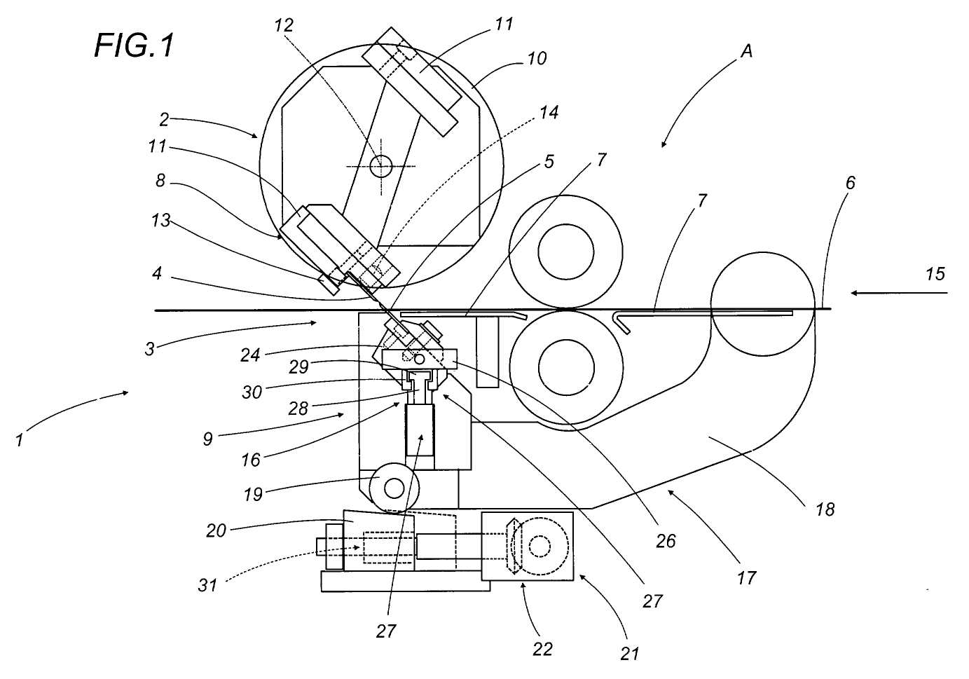

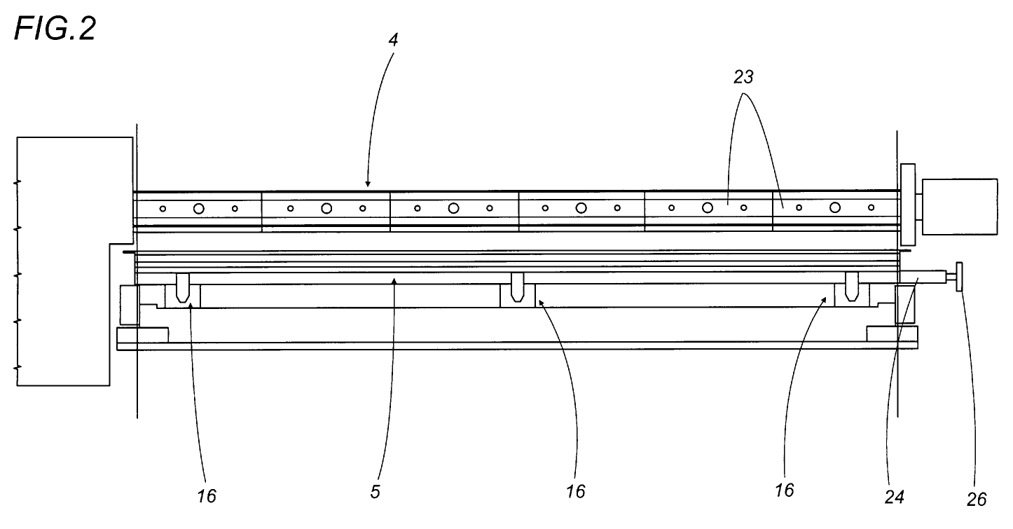

To speed up the assembly and disassembly of the support 8 and of the related blade 4 of the rotating cutter 2, the apparatus 1 is provided with related rapid locking and unlocking means which, in the specific case, can be embodied by way of example by some fastening screws 13, for instance only four screws, and by some positioning pins 14 inserted into the seat 11 in a suitable manner to allow the certain and repetitive positioning and orientation of the complex constituted by the blade-holding support 8 and by the blade 4 integral therewith. The fixed cutter 3 is also structured in such a way as to comprise a blade-holding support 9 and a blade 5 which can be removed together from the perforating apparatus 1. This feature is clearly visible in FIGS. 1 and 2 which show that the blade-holding support 9 of the fixed cutter 3 comprises an elongated element 24, of parallelepiped shape, set down and able to slide on an “L” shaped guide 25 and provided at an end with a grip handle 26. By virtue of such structuring, the fixed cutter 3 is removable with a transverse translation to the direction of advance 15 of the packing film 6 along the plane of lay 7.

The means for the rapid locking and unlocking of the blade-holding support 9 of the fixed cutter 3 are embodied in this case preferably by one ore more vices 16, pneumatically operated, applied to the blade-holding support 9, or positioned between the elongated element 24 and the related guide 25 in such a way as to allow or inhibit, as the case may be, the freedom of the blade-holding support 9 to slide along the guide 25. More in particular, each vice 16 is embodied by a pneumatic piston 27 having a stem 28 provided with a “T” shaped end 29 engaged in a complementary groove 30 of the elongated element 24. The retraction of the stem 28 determines the locking of the assembly constituted by the blade-holding support 9 and the blade 5 of the fixed cutter 3; the exit of the stem 28 instead allows the elongated element 24 to slide upon a manual action applied to the related handle 26.

The apparatus 1 further comprises a frame 17 to support the rotating cutter 2 and fixed cutter 3 in mutually adjustable fashion, even whilst the apparatus 1 itself is in use. The frame 17 is provided with an articulated arm 18 that supports the fixed cutter 3; means 19, 20, 21, 22 for actuating the arm 18 are also provided, for moving the fixed cutter 3 and the rotating cutter 2 mutually closer and farther away.

The actuating means comprise in particular a rotating cam 19 associated to an end of the articulated arm 17 and a wedge 20 peripherally abutting against the cam 19, the wedge 20 being able to translate in such a way as to impart on the cam 19 a motion such as to move the fixed cutter closer to, or vice versa farther away from, the rotating cutter 2, as needed. A mechanical drive 21 provided with angular transmission 22, of the crown wheel and pinion type, allows, by means of a screw-nut screw pair 31 for manoeuvring the wedge 20, to command the translation of the wedge 20 itself and consequently to effect the relative adjustment of the cutters 2, 3 or of their blades 4, 5, also employing possible graduated lines or reference verniers for controlling the operations.

In use, the apparatus 1 described above allows to remove from the working area, together, the blade-holding supports 8, 9 and the blades 4 and 5 associated thereto. Consequently, the apparatus 1 provides for the capability of monitoring, even frequently, the wear of the blades 4 and 5 and of rapidly and economically returning them to their full operability. Therefore, by adopting blades 4; 5 constituted by two or more blade segments 23 removable in mutually independent fashion, it is possible to configure the blades 4, 5 at each change in production setting according to the format of the packing sheet to be processed, or selectively to replace only those parts of blade 4, 5 that show signs of excessive wear: all this clearly has obvious consequences in terms of operative effectiveness and in terms of the economical operation of the apparatus 1.

The invention thus conceived is suitable for evident industrial application; furthermore, it can be subject to numerous modifications and variations, without thereby departing from the scope of the inventive concept. Moreover, all components can be replaced by technically equivalent elements.

What is claimed:

1. An apparatus for perforating a packing film (6), provided with a rotating cutter (2) and with a fixed cutter (3), respectively fitted with related single blades (4, 5), between which the packing film (6) advances proceeding along an interposed plane of lay (7), characterised in that it comprises blade-holding supports (8, 9) that are removable together with the respective blade (4, 5).

2. An apparatus as claimed in claim 1, characterised in that it comprises means (13, 14; 16) for rapidly locking and unlocking the blade-holding supports (8, 9).

3. An apparatus as claimed in claim 1, wherein the rotating blade (2) includes a rotating drum (10) provided with at least a seat (11), characterised in that said blade-holding support (8) is housed in said seat (11) which is so shaped as to be accessible in a transverse direction to the axis of rotation (12) of the drum (10).

4. An apparatus as claimed in claim 3, characterised in that the means for locking and unlocking the blade-holding support (8) are constituted by fastening screws (13) and positioning pins (14).

5. An apparatus as claimed in claim 1, characterised in that the fixed cutter (3) can be removed with a translation that is transverse to the direction of advance (15) of the packing film (6) along said plane of lay (7).

6. An apparatus as claimed in claim 5, characterised in that the means for locking and unlocking the fixed cutter (3) are constituted by at least a vice (16) applied to the blade-holding support.

7. An apparatus as claimed in claim 6, characterised in that said one or each vice (16) is operated pneumatically.

8. An apparatus as claimed in claim 1, characterised in that it comprises a frame (17) for supporting said rotary cutter (2) and fixed cutter (3) in mutually adjustable fashion, even whilst said apparatus (1) is in use.

9. An apparatus as claimed in claim 8, characterised in that said frame (17) is provided with an articulated arm (18) that supports the fixed cutter (3), means (19, 20, 21, 22) for actuating said arm (18) being provided for moving said fixed cutter (3) and said rotating cutter (2) mutually closer or farther away.

10. An apparatus as claimed in claim 9, characterised in that said actuating means comprise a rotating cam (19) associated to an end of the articulated arm (17) and a wedge (20) peripherally abutting the cam (19), said wedge (20) being translatable in such a way as to impart to the cam (19) such a motion as to move the fixed cutter (3) closer to, or vice versa farther away from, the rotating cutter (2).

11. An apparatus as claimed in claim 10, characterised in that said actuating means comprises a mechanical drive (21) provided with angular transmission (22) for commanding the translation of the wedge (20).

12. An apparatus as claimed in any of the previous claims, characterised in that at least one said blade (4; 5) includes two blade segments (23) removable in mutually independent fashion.
